(19) United States
(12) Patent Application Publication
(10) Pub. No.: US 2005/0059270 A1
(43) Pub. Date: Mar. 17, 2005

(54) Electrical connector

(76) Inventors: Qisheng Zheng, Kunsan (CN); Shaoping Du, Kunsan (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/940,277

(22) Filed: Sep. 13, 2004

(30) Foreign Application Priority Data
Sep. 12, 2003 (TW) 92216476

(51) Int. Cl. H01R 12/00

(52) U.S. Cl. 439/66

(57) ABSTRACT

An electrical connector (100) includes an insulative housing (1), a pair of contact terminals (2) retained in the housing, a pair of springs (3) and a pair of retaining contacts (4). The insulative housing defines a pair of through holes (13) through a top and bottom walls (10, 11) thereof. A horizontal recess (131) is outwardly defined in the bottom wall and communicates with the through hole. The retaining contact has a substantially dome-shaped soldering portion (410) for soldering to a printed circuit board. The retaining contact has a horizontally extending fixing slice (401) surrounding the dome-shaped soldering portion for latching into the recess of the housing.

### BACKGROUND OF THE INVENTION

1. Filed of the Invention

The present invention generally relates to an electrical connector and more particularly, to an electrical connector mounted on a printed circuit board. The instant application relates to a contemporarily filed application titled with the same applicant and the same assignee, while claims the priority of a Taiwan application 92216347 filed Sep. 10, 2003.

2. Description of the Prior Art

Relates to the present patent, referring to U.S. Pat. No. 6,340,320. In this patent, a probe pin vertically stands in an insulative housing and comprises a lower end standing in an upright sleeve enclosed by the insulative housing and an upper end upwardly exposed to outside of the housing. A coiled spring is assembled into the upright sleeve, with an upper end supporting the lower end of the probe pin, and with a lower end pressing an insulative cover, which engages with a bottom portion of the sleeve, thereby providing the probe pin with flexibility. However, being pressed by a mating force from a mating connector, the probe pin and the coiled spring press the cover. If the mating connector presses the probe pin in a relative large force, the cover tends to move downwardly relative to the sleeve, thereby decreasing the electric capability of the conventional electrical connector.

### SUMMARY OF THE INVENTION

An object, therefore, of the invention is to provide an improved electrical connector means for securely fixing springs.

In order to attain the above object, an electrical connector according to the present invention includes an insulative housing, a pair of contact terminals mounted on the housing, a pair of springs and a pair of retaining contacts. The insulative housing defines a through hole for receiving the contact terminals and springs through a top and bottom walls thereof. A pair of openings are longitudinally defined in the bottom wall. Each opening has a middle portion communicating with a corresponding through hole. A horizontal recess is outwardly defined in a lower portion of an inner periphery of each opening. The retaining contact is formed of a sheet metal and is fixed in the housing. The retaining contact has a substantially dome-shaped soldering portion for soldering to a printed circuit board. The soldering portion comprises an upwardly exposed retaining cavity for receiving the coiled spring. The retaining contact has a horizontally extending fixing edge surrounding the dome-shaped soldering portion for latching into the recess of the housing.

Other objects, features and advantages of the invention will be apparent from the following detailed description taken in connection with the accompanying drawings.

### BRIEF DESCRIPTION OF THE DRAWINGS

The features of this invention are believed to be novel are set forth with particularly in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of an electrical connector according to the present invention;

FIG. 2 is another perspective view of the electrical connector;

FIG. 3 is an exploded view of FIG. 1; and

FIG. 4 is an exploded view of FIG. 2.

### DETAILED DESCRIPTION OF THE INVENTION

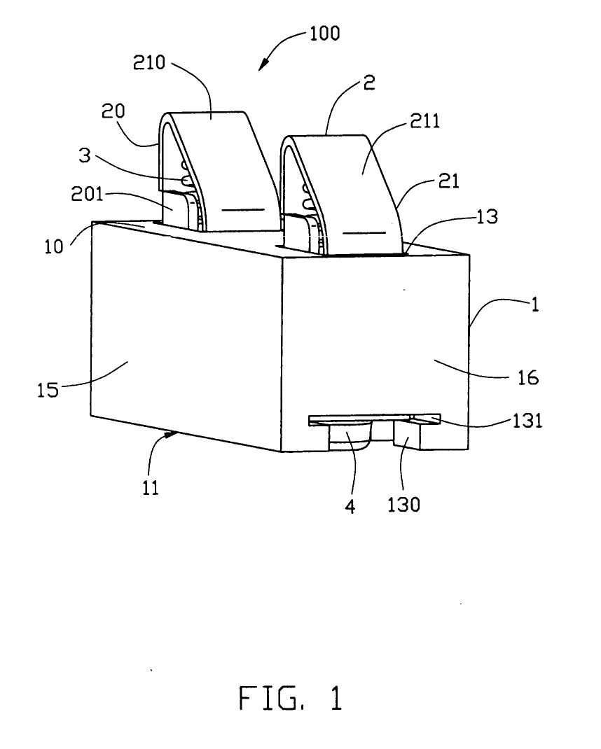

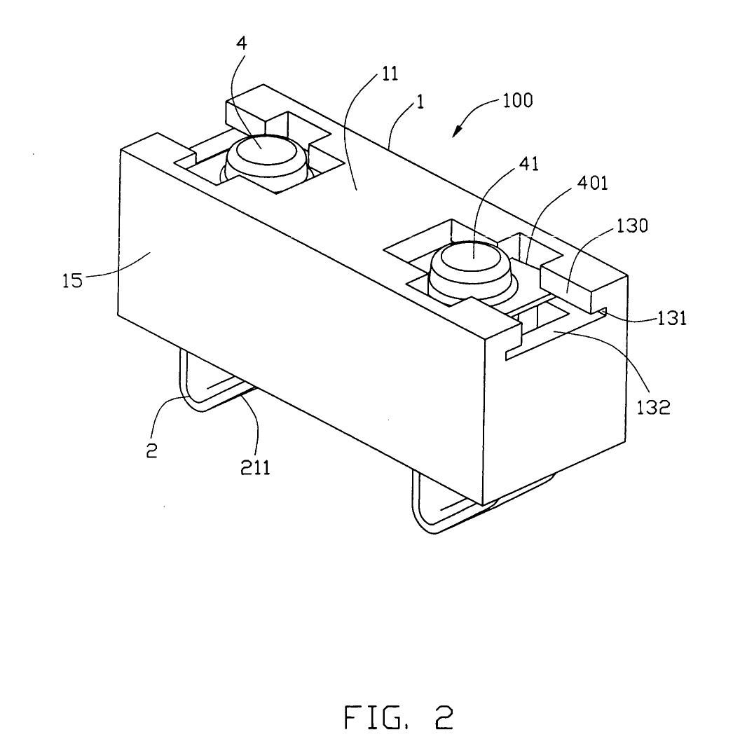

Referring to FIGS. 1-4, the present invention 100 includes an insulative housing 1, a pair of contact terminals 2 retained in the housing 1, a pair of springs 3 and a pair of retaining contacts 4.

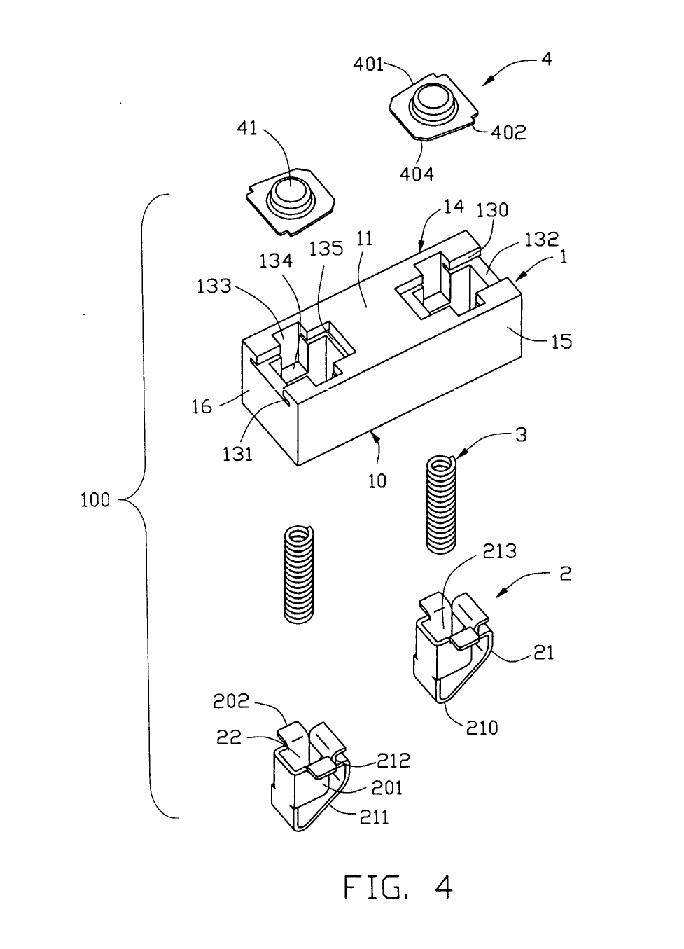

Referring to FIG. 4, the insulative housing 1 is substantially rectangular and includes a top wall 10, a bottom wall 11, a longitudinally extending front wall 14, an opposite rear wall 15 and opposite side walls 16. A pair of through holes 13 are defined through the top and the bottom walls 10, 11 and are adjacent to corresponding side walls 16 of the housing 1. Two pairs of slots 133 extend through the bottom wall 11 and are respectively adjacent to the front and rear walls 14, 15. Each pair of slots 133 is opposite to each other and communicates with a corresponding through hole 13. A projecting portion 134 downwardly projects into each slot 133 from the top wall 10. A pair of rectangular-shaped openings 130 are longitudinally defined in the bottom wall 11. Each opening 130 has a middle portion communicating with a corresponding through hole 13. The openings 130 extend through middle portions of corresponding side walls 16 and inwardly extend to each other. The through holes 13, slots 133 and openings 130 cooperatively define a receiving space (not labeled) for receiving the contact terminals 2, the springs 3 and retaining contacts 4. Therefore, cross sections of the receiving space adjacent to the bottom wall 11 are generally of cross-shape. Cross sections of the receiving space adjacent to the top wall 10 are of generally rectangular. A horizontal recess 131 outwardly extends in a lower portion of an inner periphery of each opening 130. The recesses 131 communicate with corresponding slots 133 and through holes 13.

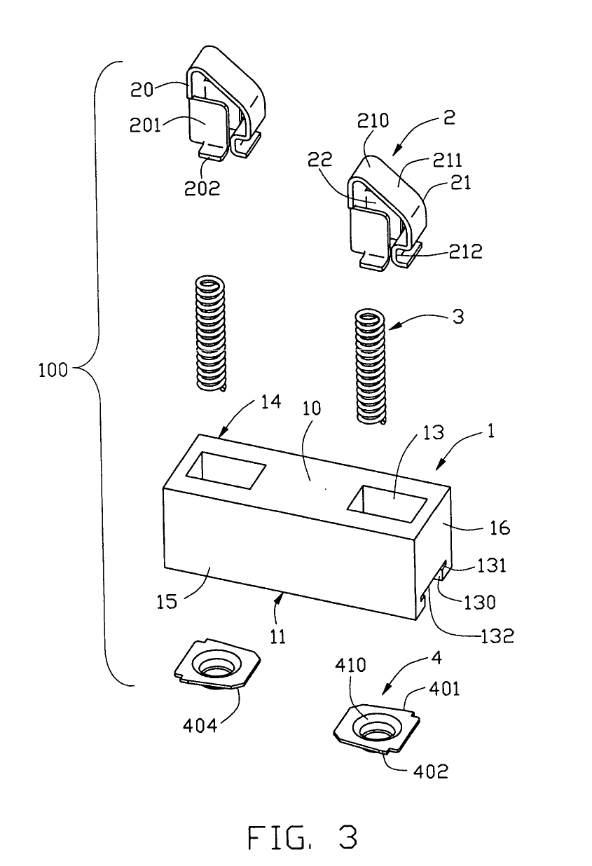

Referring to FIG. 3 in conjunction with FIG. 4, the contact terminals 2 are formed by stamping and are mounted in the insulative housing 1. Each contact terminal 2 includes a substantially rectangular body portion 20 and a cantilevered beam 21 downwardly and angularly extending from a top portion of the body portion 20, thereby having a substantially V-shaped configuration. The body portion 20 has a pair of wings 201 perpendicularly bending toward the cantilevered beam 21 from opposite side edges thereof. A receiving room 22 is defined by the body portion 20, the wings 201 and the cantilevered beam 21. Each wing 201 has a flange 202 outwardly and transversely extending from a bottom edge thereof. The contact terminal 2 has an upwardly projecting contact portion 210 on a top portion thereof for interconnecting the body portion 20 and the cantilevered beam 21. The cantilevered beam 21 comprises an outer leading face 211 extending downwardly and angularly from the contact portion 210. A mating electrical device (not shown) can slide upwardly along the lead face 211 to electrically connect with the contact portion 210. The cantilevered beam 21 further has an engaging portion 212 downwardly extending from a bottom end of the leading face 211. The engaging portion 212 is of a generally U-shaped configuration and projects inwardly to substantially abut against side edges of wings 201. Each contact terminal 2 has a generally quadrate lower mouth 213 defined by the body portion 20, the wings 201 and the engaging portion 212.

Each spring 3 is received in the receiving room 22 of the contact terminal 2. The springs 3 are coiled springs in the present invention and interconnect the contact terminals 2 and the retaining contacts 4. The outer diameter of each coiled spring is substantially corresponding to an inner periphery of a corresponding quadrate receiving cavity 213 of the contact terminal 2.

The retaining contact 4 is formed of a sheet metal and is fixed in the housing 1. The retaining contact 4 has a substantially dome-shaped soldering portion 41 downwardly stamped from a substantially central portion thereof for soldering to a printed circuit board (not shown). The dome-shaped portion 41 comprises an upwardly exposed retaining cavity 410 for receiving the coiled spring 3. The soldering portion 41 protuberates beyond the bottom wall 11 for facilitating soldering the retaining contact 4 to the printed circuit board. The retaining contact 4 has a horizontal extending fixing edge 401 surrounding the dome-shaped soldering portion 41 for latching into the recesses 131 of the housing 1. Thickness of the fixing edge 401 is substantially equal to that of the recess 131 of the housing 1. The fixing edge 401 has a pair of protuberant barbs 402 outwardly projecting from a rear portion thereof for securely engaging with the recess 131 of the housing 1. The fixing edge 401 has a pair of angular guiding sections 404 cut from opposite sides of a front portion thereof for facilitating inserting the retaining contact 4 into the recess 131 of the housing 1.

Referring to FIGS. 1-4, in assembly, firstly, the contact terminals 2 are upwardly inserted into the housing 1 from a bottom of the through hole 13. The flanges 202 of the wings 201 of the contact terminals 2 are respectively inserted into the housing 1 along the slots 133 and abut against the projecting portions 134. The lead face 211 and contact portion 210 of the contact terminal 2 projects beyond the top wall 10 of the insulative housing 1. Secondly, an upper end of the spring 3 is inserted into the receiving room 22 of the contact terminal 2 from the quadrate lower mouth 213 of the contact terminal 2. Finally, the retaining contacts 4 cover the openings 130 of the bottom wall 11 of the housing 1 with the fixing edges 401 latching into the recesses 131. The retaining holes 41 engage with lower ends of the springs 3. The soldering portion 410 of each retaining contact 4 is soldered to the printed circuit board so that the electrical connector 100 can electrically connect with the printed circuit board.

In use, if a mating electrical connector is horizontally pushed to contact with the lead face 211 of the contact terminal 2 and upwardly slides along the lead face 211. The lead face 211 is exerted a downward pressing force. As a result, the spring 3 is compressed and the contact terminal 2 is downwardly pressed. The mating electrical connector (battery, SIM card etc. not shown) is leaded by the leading surface 211 of the contact terminal 2 and contacts with the contact portion 210 of the contact terminal 2. Alternatively, the mating electrical connector can press the contact portion 210 in a top-to-bottom direction, thereby electrically connecting with the electrical connector 100.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. An electrical connector adapted for mounting on a printed circuit board comprising:
an insulative housing comprising a top wall and a bottom wall and defining a through hole through the top and bottom walls thereof and defining a substantially horizontal recess in the bottom wall communicating with the through hole;
a contact terminal retained in an upper portion of said through hole of the housing and extending beyond the top wall of the housing;
a retaining contact fixed in a lower portion of the through hole and comprising a horizontally extending fixing edge for latching into the recess of the housing and a soldering portion for soldering to the printed circuit board; and
a spring secured between the retaining contact and the contact terminal.

2. The electrical connector according to the claim 1, wherein said insulative housing includes a side wall and defines an opening in the bottom wall thereof communicating with the through hole, the opening extending beyond the side wall, and wherein said recess of the housing communicates with a lower portion of the opening.

3. The electrical connector according to the claim 1, wherein said soldering portion is downwardly stamped from a substantially central portion of the retaining contact and has a substantially dome-shaped configuration, and wherein said fixing edge surrounds the dome-shaped soldering portion.

4. The electrical connector according to the claim 3, wherein thickness of said fixing edge is substantially equal to that of the recess of the housing.

5. The electrical connector according to claim 3, wherein said dome-shaped soldering portion comprises an upwardly exposed retaining cavity for receiving the spring terminal.

6. The electrical connector according to claim 1, wherein the fixing edge has a pair of angular leading sections and protuberant barbs for engaging with said recess of the housing respectively positioned on front portion and rear portion thereof.

7. An electrical connector adapted for mounting on a printed circuit board comprising:
an insulative housing defining a through hole extending in a first direction and a recess extending in a second direction, the through hole having a first end portion and a second end portion, the recess adjacent to the second end portion, the first direction substantially perpendicular to the second direction;
a contact terminal retained in the first end portion of the through hole; and
a retaining contact fixed in the second end portion of the through hole.

8. An electrical connector comprising:
an insulative housing defining a through hole along a first direction and a recess along a second direction being in a non-parallel relation with regard to said first direction;
a contact terminal inserted into the through hole in the first direction with a mating end exposed outside of the housing for coupling to a complementary electronic part; and
a retaining contact inserted into the recess in the second direction with a mounting end outside of the housing for mounting to another electronic part; wherein
a biasing device is positioned between the contact terminal and the retaining contact for not only urging the contact terminal away from the retaining contact but also electrically connecting both said contact terminal and said retaining contact.

9. The electrical connector as claimed in claim 8, wherein said second direction is perpendicular to said first direction.
